(19) United States
(12) Patent Application Publication
(10) Pub. No.: US 2002/0046060 A1
(43) Pub. Date: Apr. 18, 2002

(54) System and method for generating a meal plan

(75) Inventors: Donald J. Hoskyns, Glendale, AZ (US); Donald J. Conrad, Phoenix, AR (US); Shane D. Edmonds, Gilbert, AZ (US); Daniel J. Gardner, Scottsdale, AZ (US); Curtiss A. Prickett, Scottsdale, AZ (US); Michaleen McGarry, Phoenix, AZ (US); Peter Moore, Boca Raton, FL (US); Brian Dunnington, Phoenix, AZ (US)

Correspondence Address: Kim R. Jessum, Morgan, Lewis & Bockius LLP, 1701 Market Street, Philadelphia, PA, 19103, US

(73) Assignee: Fitness Venture Group

(21) Appl. No.: 09/923,015

(22) Filed: Aug. 6, 2001

Related U.S. Application Data
(60) Provisional application No. 60/222,986, filed on Aug. 4, 2000.

(51) Int. Cl. G06F 17/60

(52) U.S. Cl. 705/2

(57) ABSTRACT

A multi-user meal planner for providing users with an individually customized, daily meal plan is disclosed. The multi-user meal planner includes a user interface and a relational database management system. The database management system includes nutritional information and an algorithm operationally connected to the nutritional information. The database management system further includes user information that is inputted through the user interface. After being inputted through the user interface, the user information is processed by the algorithm. The algorithm generates a meal plan for the user and the database management system transmits the meal plan to the user interface. A method of providing the individualized meal plan is also provided.

### REFERENCE TO RELATED APPLICATION

This application claims the benefit of U.S. Provisional Application No. 60/222,986, filed Aug. 4, 2000, incorporated herein by reference.

### FIELD OF THE INVENTION

The present invention relates to a networked system for providing a meal plan to a user based on information provided by the user.

### BACKGROUND OF THE INVENTION

A meal-planning system may aid individual users in achieving their optimal daily nutritional levels by generating a meal plan that is customized to each individual user. One meal-planning system may provide users with a meal plan that consists of a maximum of three meals per day. The generated meals may have unalterable recipes and the system may not have the capability to generate ingredient lists based on the meal plan. The system may be on a CD and may have a single-user capacity.

It is believed that it would be beneficial to provide a system in which users have several eating schedule options, as opposed to one eating schedule of three meals per day. The flexibility would benefit users who eat larger numbers of smaller meals or who snack in between meals. The ability to choose from among several different eating schedule options would make the transition into a meal program more manageable for those users who do not usually eat a fixed three meals per day.

In addition, it is believed that it would be beneficial to provide a system in which users could modify their meals. Modification, including exchange of meals and meal ingredients, would result in a more manageable transition into the program, as users could adjust the meals to their desired tastes and daily preferences.

It is also believed that a system having the capability to generate ingredient lists based on the meal plan would benefit the users. Generation of ingredient lists would save the users the time of going through the meal plan and determining the amount of each ingredient that is needed for the meals in the meal plan.

Additionally, it is believed that it would be beneficial to have the meal-planning system available on a networked system. A networked system would allow the system to be accessed by numerous simultaneous users.

### SUMMARY OF THE INVENTION

The present invention provides a multi-user meal planner. The multi-user meal planner comprises a user interface and a relational database management system operationally connected to the user interface. The relational database management system includes nutritional information, an algorithm operationally connected to the nutritional information and user information. The user information is inputted through the user interface, wherein the algorithm processes the information and generates a meal plan. The database management system transmits the meal plan to the user interface.

The present invention also provides a method of obtaining an individualized meal plan via a networked computer system. The method comprises accessing the computer system; inputting at least one of personal information, ethnic food preferences, protein preferences, carbohydrate, protein and fat preferences, a desired number of meals per day, a desired type of meals per day, and beverage preferences; and obtaining the meal plan based on at least one of the information and preferences inputted into the system.

Additionally, the present invention provides a method of providing an individualized meal plan system. The method comprises providing an input field in a database management system, the input field adapted to receive information inputted by a user; transmitting the information to an algorithm in the database management system; generating a meal plan based on the information; and transmitting the meal plan to the user.

### BRIEF DESCRIPTION OF THE DRAWINGS

FIGS. 1a-d are schematic drawings of the preferred embodiment of the meal planning system.

FIG. 2 is a schematic drawing of the information interchange between a user and the system.

FIG. 3 is a flow chart of the steps for generating a modifiable meal plan.

FIG. 4 is a representative user interface of a first sign-up screen requesting general demographic information.

FIG. 5a is a representative user interface of a second sign-up screen requesting physical metric information.

FIG. 5b is a representative user interface of a body fat calculation screen.

FIG. 5c is a representative user interface of a resting heart rate determination screen.

FIG. 6 is a representative user interface of a third sign-up screen requesting medical information.

FIG. 7 is a representative user interface of a fourth sign-up screen requesting answers to a goal questionnaire.

FIG. 8 is a representative user interface of a fifth sign-up screen requesting ethnic food preference information.

FIG. 9 is a representative user interface of a sixth sign-up screen requesting protein preference information.

FIG. 10 is a representative user interface of a seventh sign-up screen requesting the selection of a carbohydrate/protein/fat ratio.

FIG. 11 is a representative user interface of an eighth sign-up screen requesting the selection of a meal pattern for the meal plan.

FIG. 12 is a representative user interface of a ninth sign-up screen requesting beverage preference information.

FIG. 13 is a representative user interface of a generated meal plan for a specific day.

FIG. 14 is a representative user interface of preparation instructions for a specific meal.

FIG. 15 is a representative user interface of a list of complete nutritional information for a specific day.

FIG. 16 is a representative user interface of an ingredient list for a specific day.

FIG. 17 is a representative user interface of a screen that gives a user several options for modifying a specific meal.

FIG. 18 is a representative user interface of a screen that gives a user several options for exchanging a specific meal for an alternate meal.

FIG. 19 is a representative user interface of a screen that gives a user the option of exchanging a specific meal for an alternate meal through an advanced search for an alternate meal.

FIG. 20 is a representative user interface of a screen that gives a user several options for modifying the ingredients of a specific meal item.

### DETAILED DESCRIPTION OF THE PREFERRED EMBODIMENTS

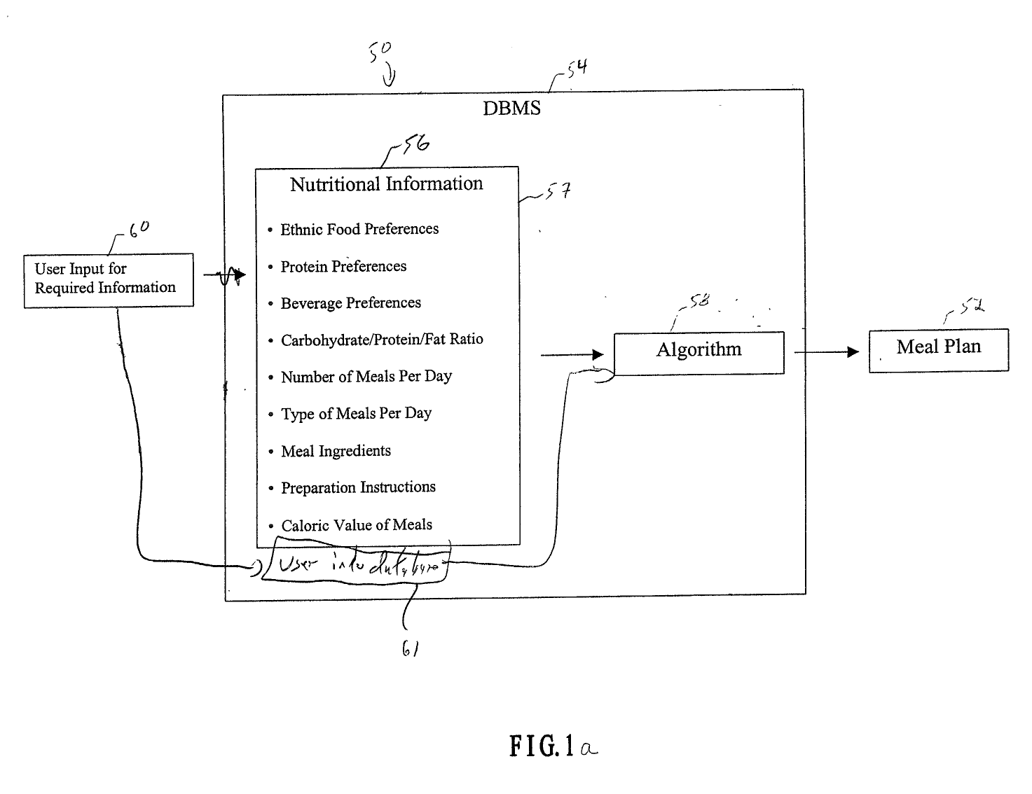

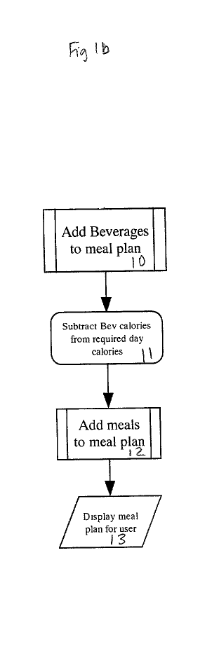

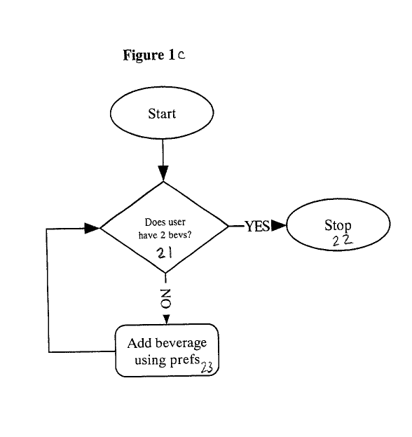

A preferred embodiment of a system 50 used during the operation of the present invention is shown in schematic drawings, FIGS. 1a-d. The system 50 is a multi-user meal planner. Specifically, the system 50 is a networked interactive computer system for providing individually customized, modifiable daily meal plans 52 to users. The system 50 includes a relational database management system (DBMS) 54, comprising nutritional information 56 in a database 57 and an algorithm 58 that is operationally connected to the database 57. The nutritional information 56 includes ethnic food, protein and beverage preferences, carbohydrate/protein/fat calorie ratios, caloric values, number and type of meals per day, meal ingredients, and preparation instructions. The system 50 accepts user information 60 which is loaded into a user information database 61. The nutritional information 56 and the user information 60 are inputted into the algorithm 58 to generate the meal plan 52.

Details of the algorithm 58 are shown in FIGS. 1b-1d. Beverages are added to the meal plan 52 in step 10 and the calories of the added beverages are subtracted from calories required in a day in step 11. The required calories are calculated based on demographic and physical metric information, which is further discussed below. Step 10 is further described in FIG. 1c, where a determination of whether the user has two beverages is made in step 21. If there are two beverages, the determination stops in step 22, and if there are not two beverages, the process adds beverages to the meal plan in step 23.

After the beverages are added, meals are added to the meal plan in step 12. Step 12 is further described in FIG. 1d, where a determination of whether the meal plan is complete is performed in step 31. The determination may be based on the required calories. If the answer is yes, the process stops in step 32 and proceeds back to FIG. 1b, where the meal plan is displayed to the user in step 13. If the answer is no, a random meal is taken from the DBMS 54 in step 33. In step 33, a list of meals that matches the user's preferences is extracted from the DBMS 54. From this list, a single meal is randomly selected. Then, it is determined whether a meal has been used in the last seven days in step 34. If it has, step 33 is repeated, where the random meal is discarded and another meal is tested. This step 33 continues until a suitable meal is found. If the meal has not been used in the last seven days, the random meal is selected as the desired meal and required meal servings are calculated in step 35. A meal is added to the meal plan in step 36, and step 31 is repeated.

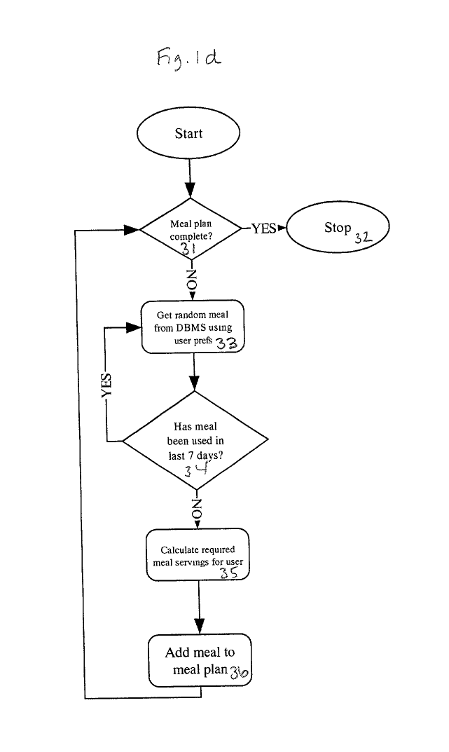

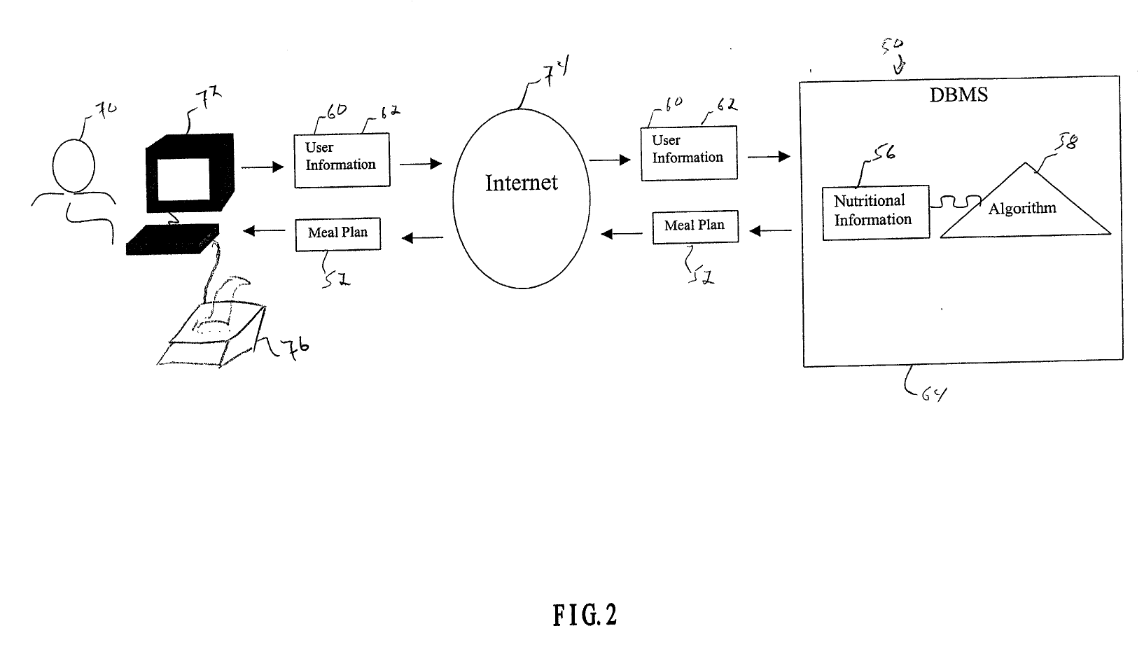

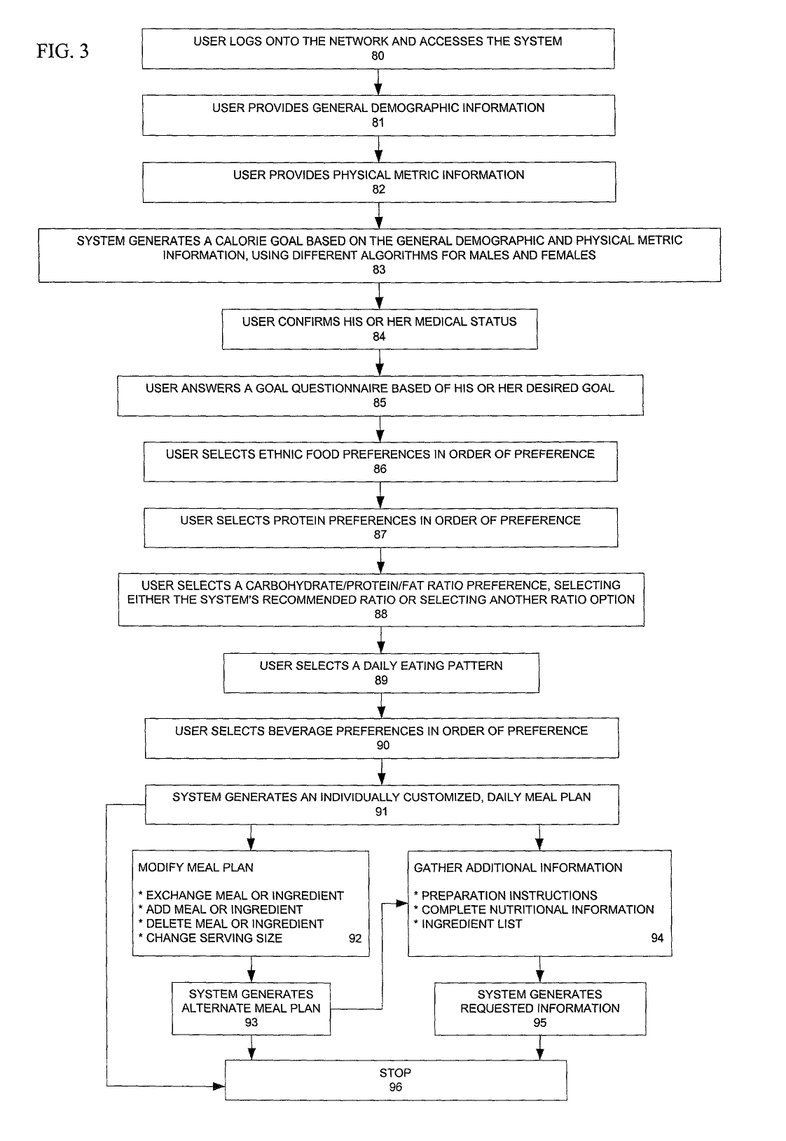

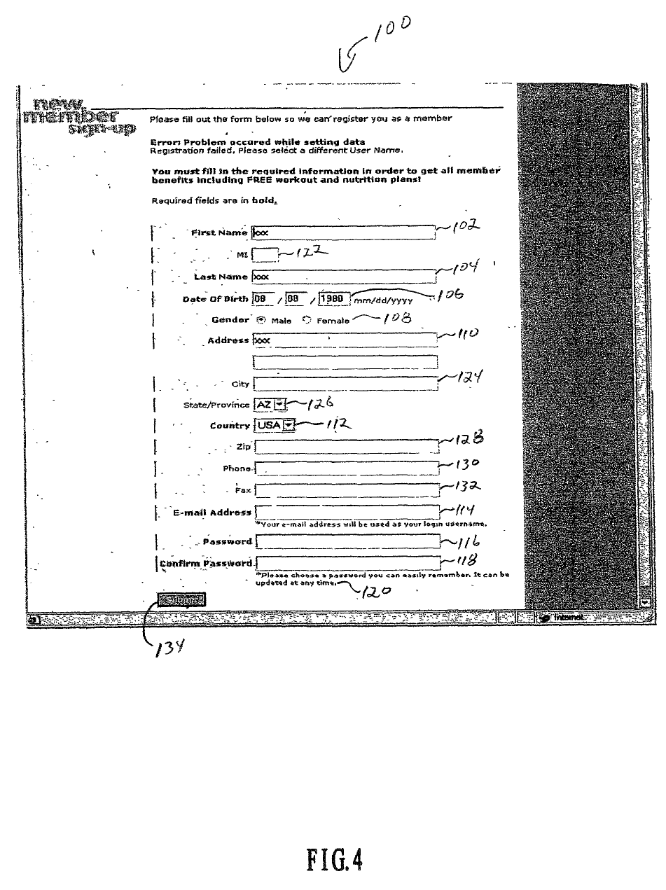

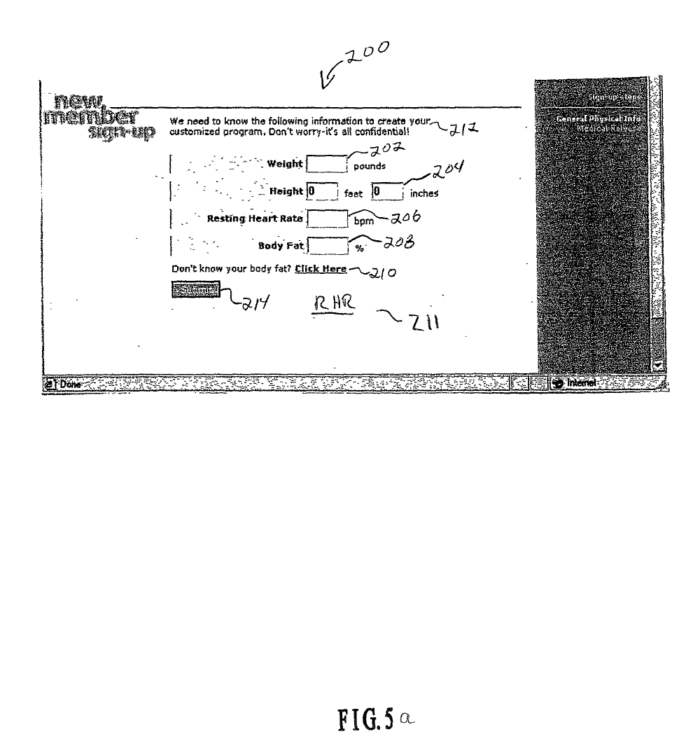

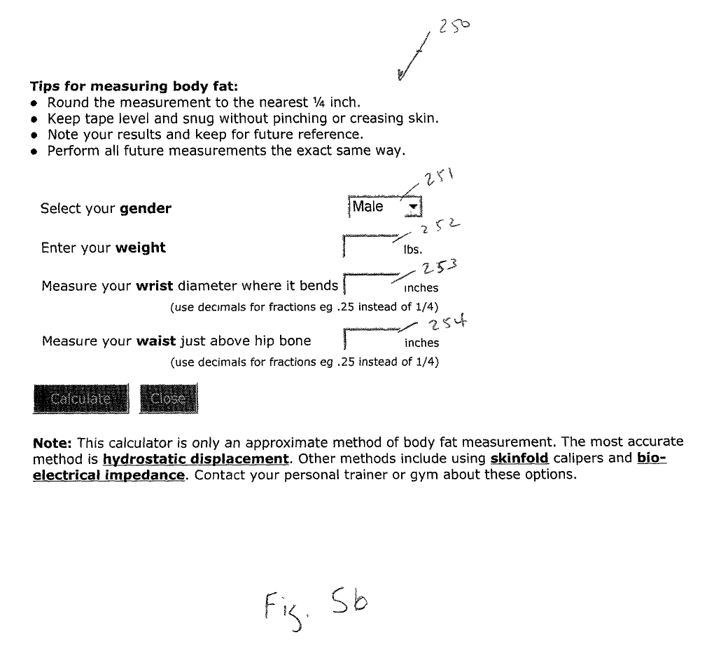

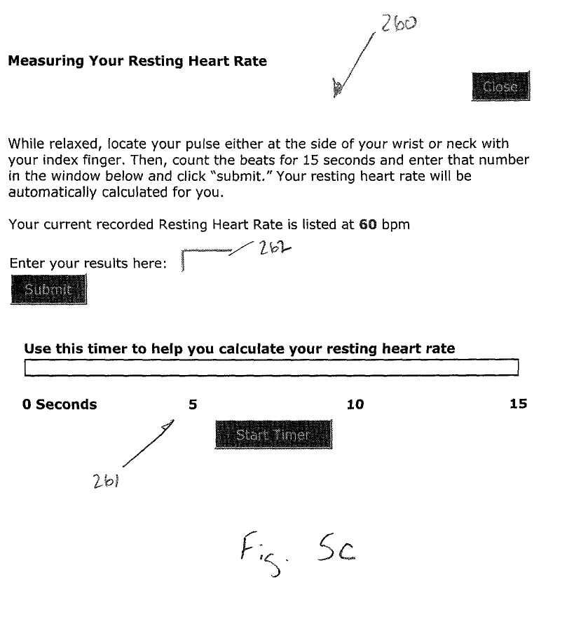

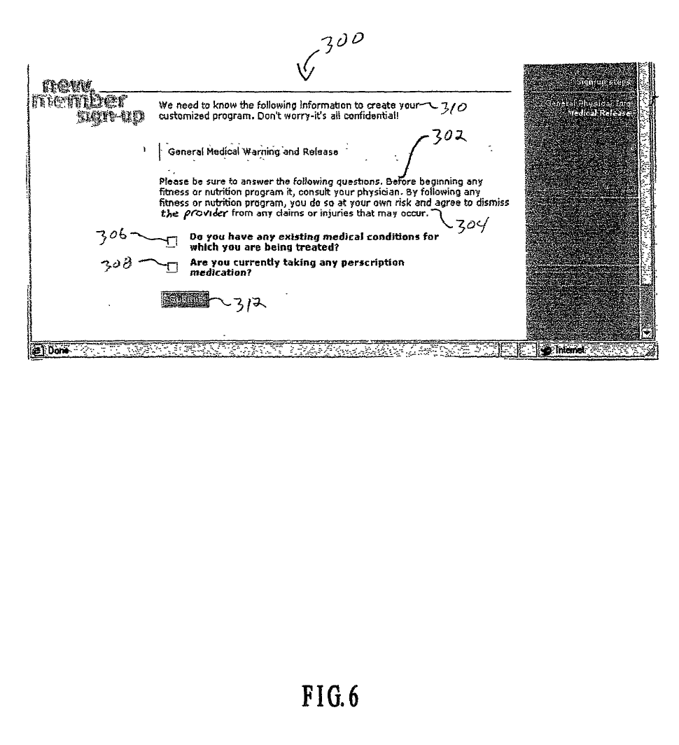

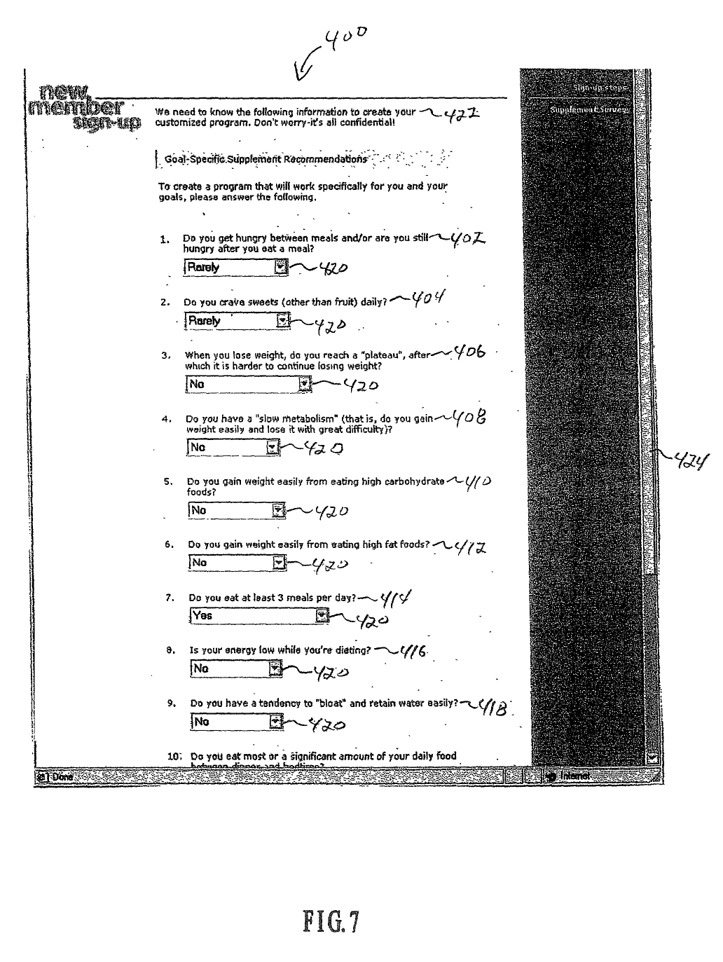

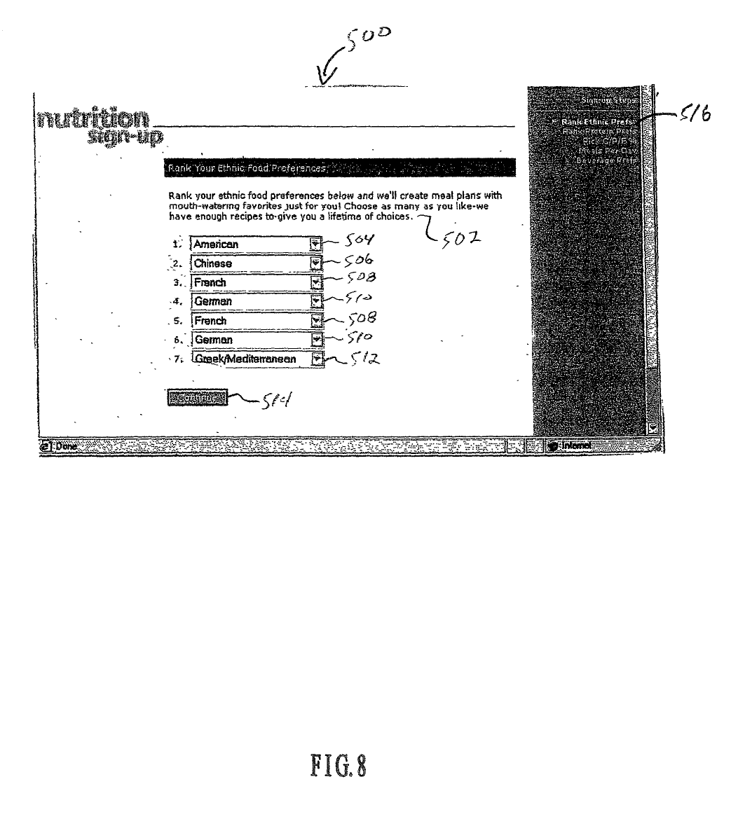

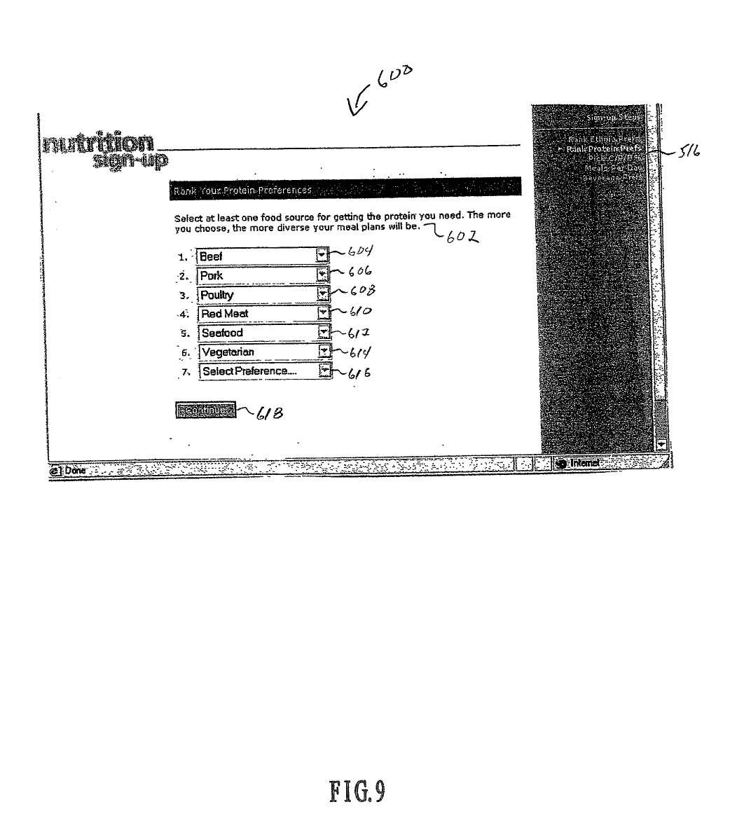

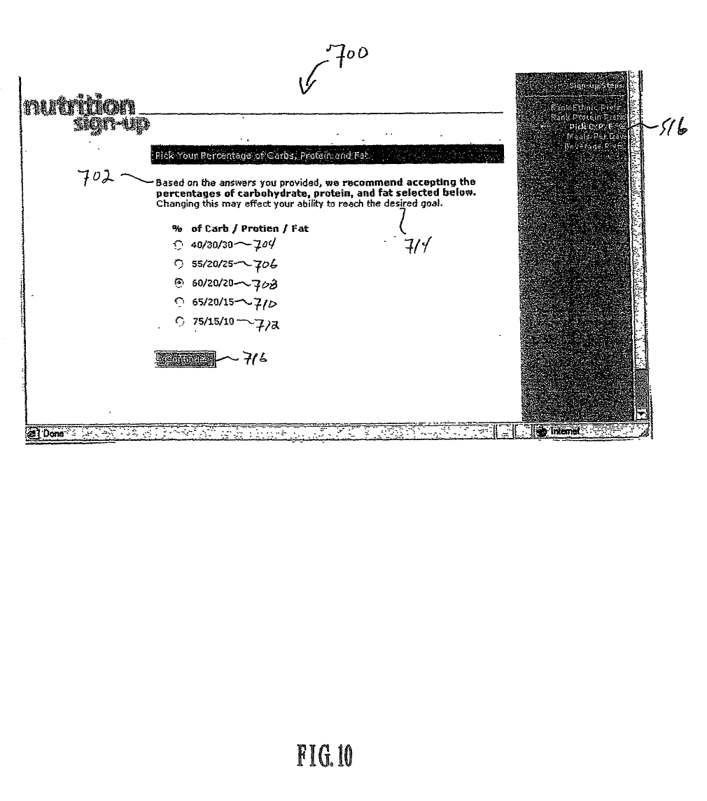

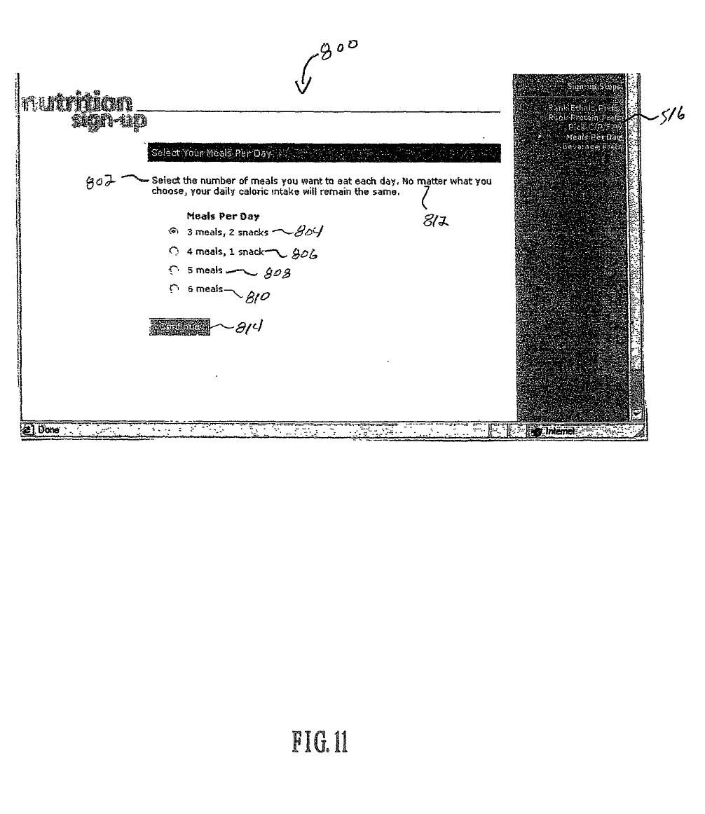

Referring to FIG. 2, the system 50 is contained on a first computer system 64. The system 50 is typically accessed by a user 70 from a second computer system 72, such as a personal computer, a laptop computer, or other personal device, including a portable personal data assistant, a mobile telephone, or a pager. Preferably, the first computer system 64 communicates with the second computer system 72 via a communication link, such as the Internet 74, although those skilled in the art will recognize that other communication media, such as radio frequency, light, and other media known or as yet unknown, can be used. Typically, the second computer system 72 has a printer 76 so that the user 70 can print out a copy of the meal plan 52 provided by the system 50. For example, the system 50 is adapted for use on one of a plurality of platforms, including the Internet, a CDROM or a client/server LAN environment. User information 60, 62 and the meal plan 52 are transmitted between the first computer system 64 and the second computer system 72 across the Internet 74, as shown schematically in FIG. 2.

The nutritional information 56 and the algorithm 58 are operationally connected so that the meal plan 52 generated by the system 50 is consistent with the user 70's nutritional goals and meal preferences. To do so, the algorithm 58 takes the user information 60 inputted the DBMS 54 the first time a specific day is viewed. By returning to a specific day more than once, the same meal plan 52 is displayed.

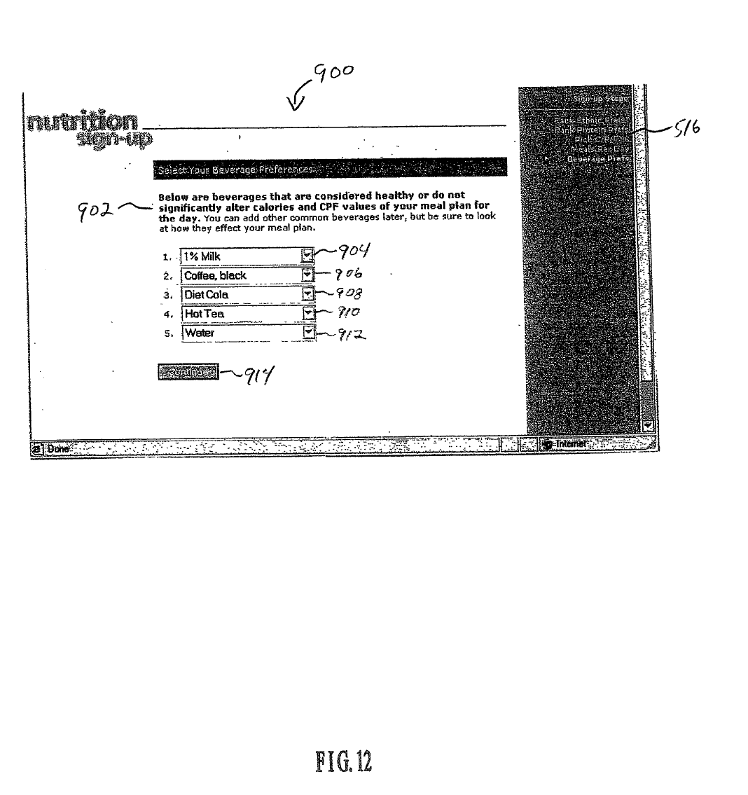

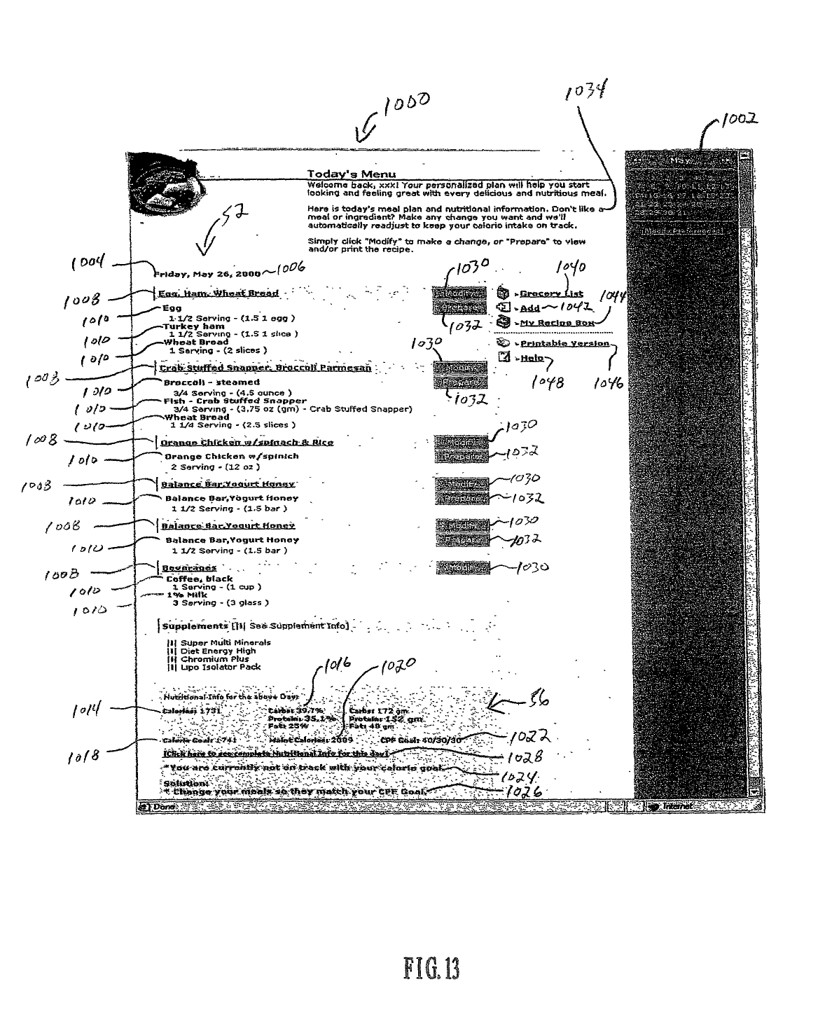

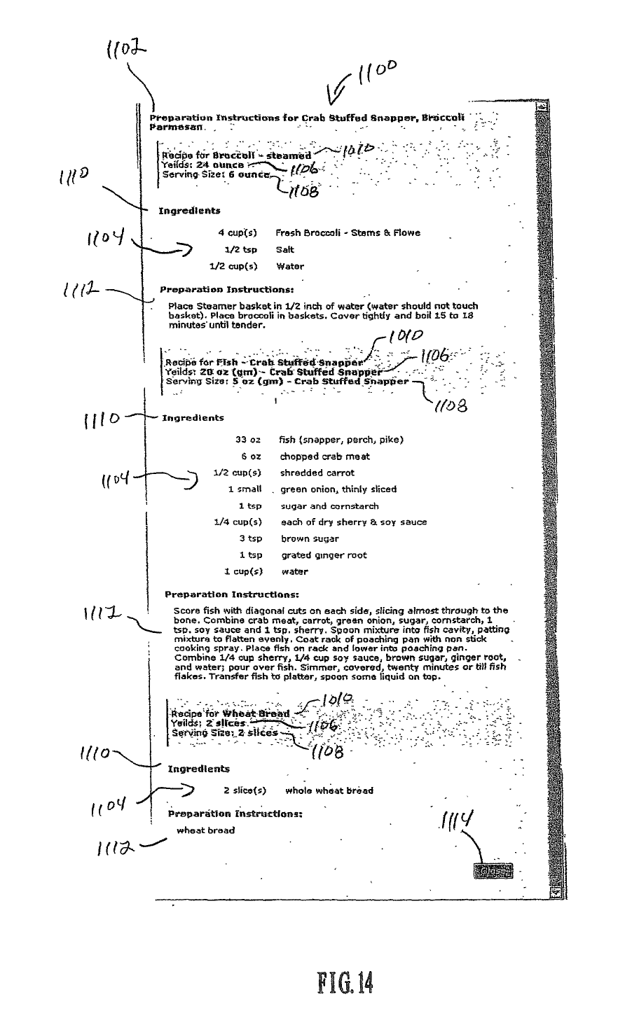

If the user 70 is satisfied with the meal plan 52 for the current day, the user 70 can obtain food preparation instructions 1112 by clicking on the “Prepare” hyperlink 1032 next to the desired meal 1008 in FIG. 13. The user 70 is then presented with the eleventh screen 1100 that lists the amounts and types of ingredients 1110 within each recipe of the selected meal 1008, as shown in FIG. 14. The user 70 is also presented with specific preparation or cooking instructions 1112 for the meal 1008. To return to the eleventh screen 1100, the user 70 clicks on the “Close” button 1114.

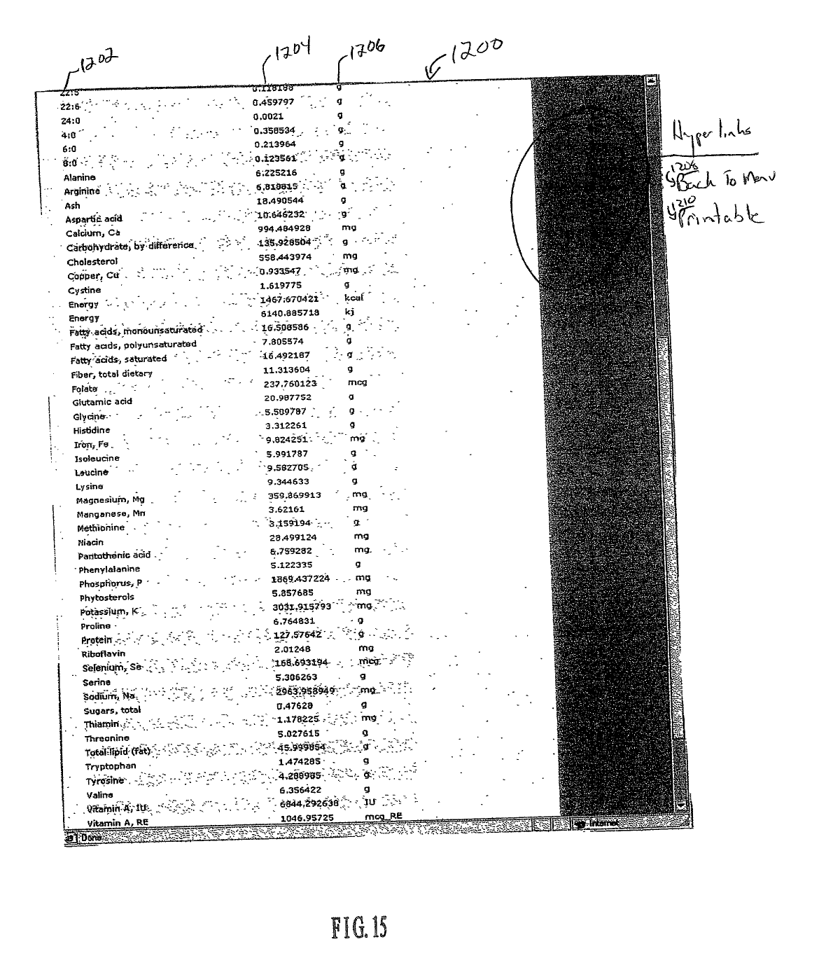

If the user 70 wants to see a complete list of nutritional information 56 for the day, the user 70 can click on the “Nutritional Info” hyperlink 1028 at the bottom of the screen 1000 in FIG. 13. The user 70 is then presented with the twelfth screen 1200, which provides as list of the types of substances 1202 and amounts 1204, 1206 within the day's meals, as shown in FIG. 15. The types of substances 1202 on the list of nutritional information include vitamins, minerals and compounds. The user 70 can read and/or print out the list to the printer 76 for reference. Printing varies depending on user 70's computer 72. A printable version can be viewed by clicking “Printable Version” 1208. Alternatively, if the user 70 is using a remote device, such as a personal data assistant or a mobile telephone, the user 70 can display the list on the remote device.

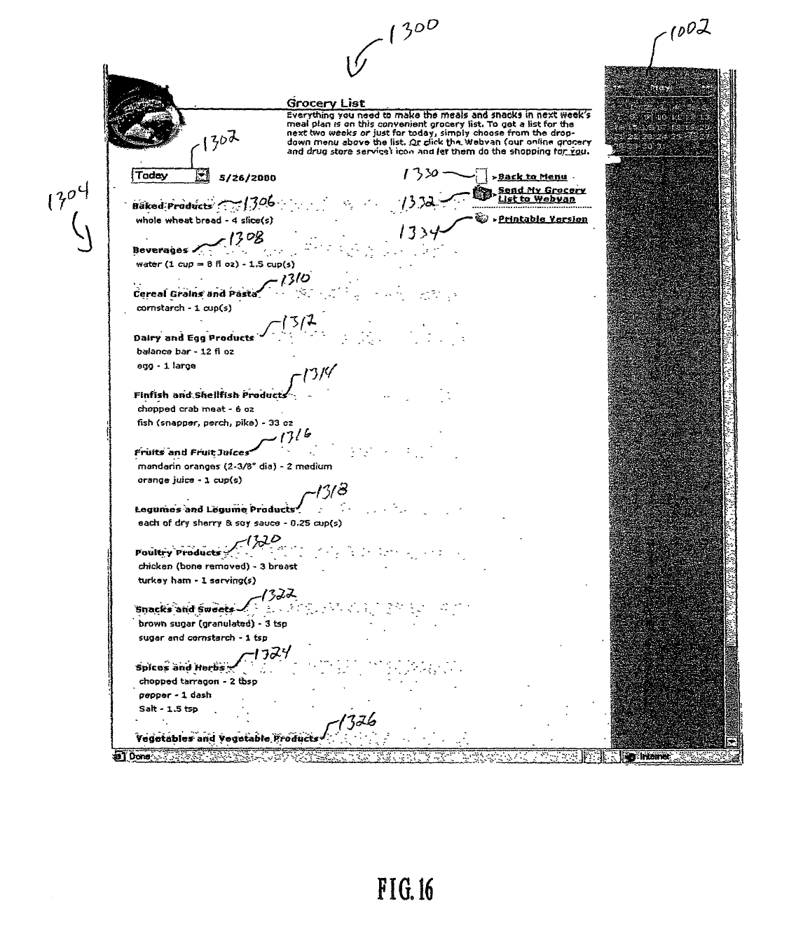

Referring back to FIG. 13, the user 70 may also view the ingredient list 1304 by clicking on the “Grocery List” hyperlink 1040. The user 70 is then presented with the thirteenth screen 1300, which provides the list of the amounts and types of ingredients 1110 needed to prepare all of the meals 1008 in the meal plan 52 for a day, for a week or for two weeks, as shown in FIG. 16. The DBMS 54 groups the ingredients into common categories. The user 70 can print out the list to the printer 76 to assist the user 70 in obtaining the ingredients. Alternatively, if the user 70 is using a remote device, such as a personal data assistant or a mobile telephone, the user 70 can display the list on the remote device.

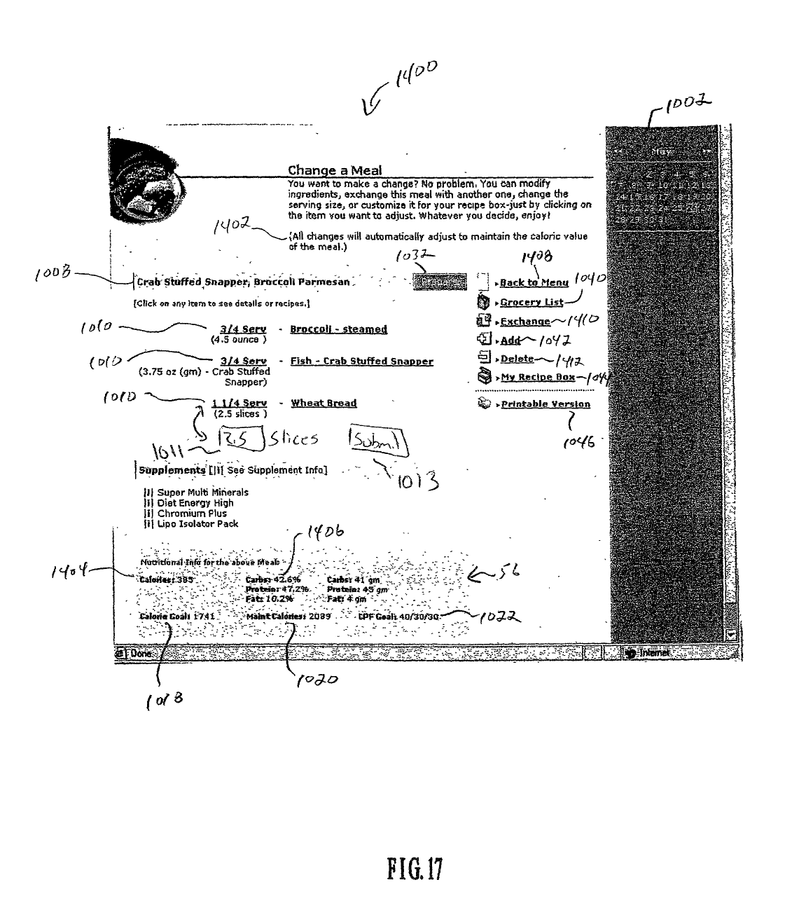

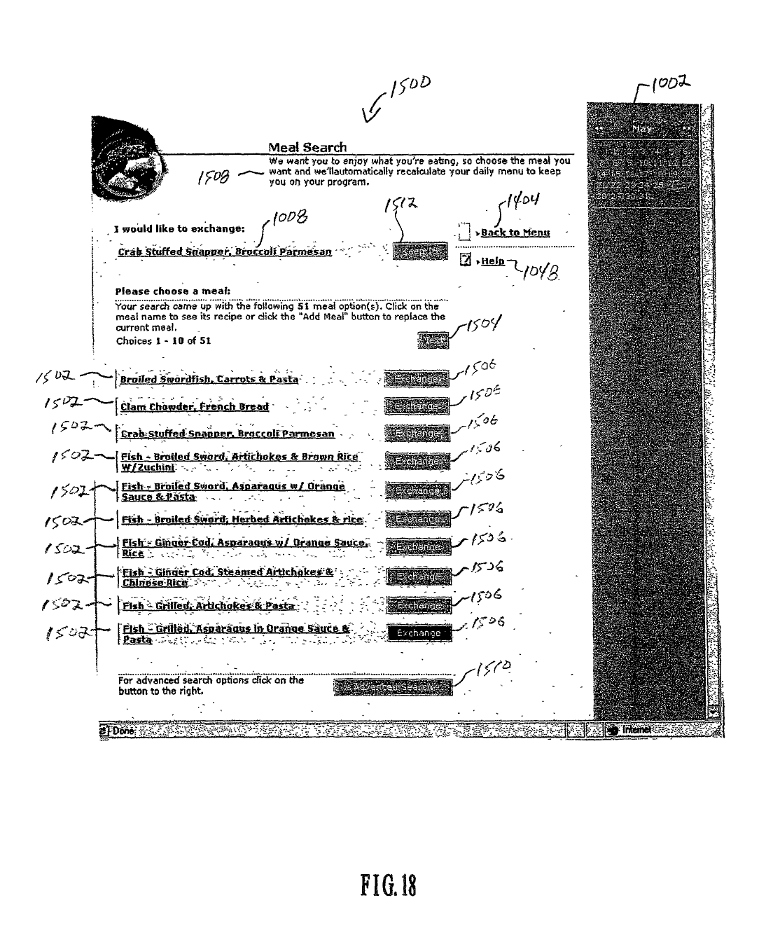

Referring back to FIG. 13, if the user 70 is unsatisfied with the meal plan 52 that the system 50 generates, the user 70 may intervene and modify the meal plan 52 at various levels by clicking on the “Modify” hyperlink 1030 next to the meal 1008 which the user 70 desires to modify. The user 70 is then presented with the fourteenth screen 1400, providing the user 70 several options for adjusting the original meal, as shown in FIG. 17. The user 70 may change the serving size of the meal 1008, add a meal 1008 and/or remove a meal 1008. The service size is changed by clicking on link 1010, which converts to a text box 1011, and a submit button 1013. A meal 1008 may be added by clicking on link 1042, which takes the user 70 to a new screen 1800 to begin searching for a meal and removed by clicking on link 1412. In addition, the user 70 may exchange the meal 1008 with an alternate meal 1502 by clicking on the “Exchange” hyperlink 1410 in FIG. 17. After clicking on the hyperlink 1410, the user 70 is presented with alternate meals 1502, as shown on the fifteenth screen 1500 in FIG. 18. Alternate meals 1502 within the desired carbohydrate/protein/fat ratio 1022 are visually offset. If the user 70 decides to exchange the original meal 1008 for an alternate meal 1502, the user 70 clicks on the hyperlink 1506 next to the alternate meal 1502, and the DBMS 54 processes the change request and recalculates the daily menu to provide a recommended serving size of the alternate meal 1502 to keep the user 70 on his or her program.

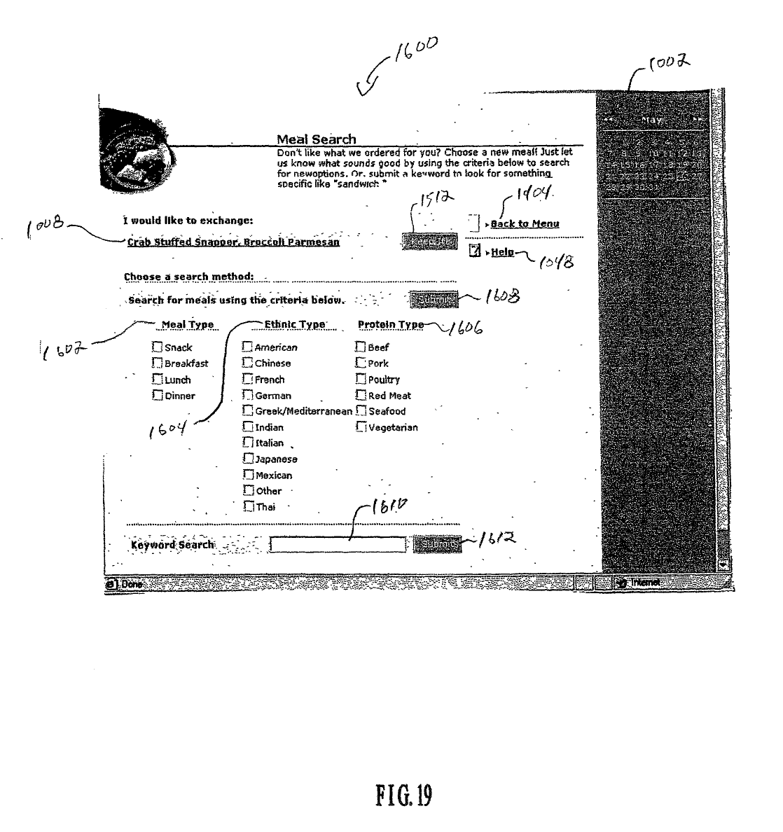

The user 70 may also enter an advanced search before exchanging the current meal 1008 for an alternate meal 1502 by clicking on the “Advanced Search” hyperlink 1510 in FIG. 18. After clicking on the hyperlink 1510, the user 70 is presented with the sixteenth screen 1600 that gives the user 70 the option of selecting the alternate meal 1502 based on alternate preferences of meal type 1602, ethnic type 1604, and/or protein type 1606, as shown in FIG. 19. For the example shown in FIG. 19, if the original meal 1008 is crab stuffed snapper and broccoli parmesan, the user 70 may want an alternate meal that has lunch as the meal type, Mexican as the ethnic type and beef as the protein type. The user 70 clicks on the boxes next to those choices and clicks on the “Submit” button 1612. The DBMS 54 processes the inputted information and provides the alternate meal 1502 based on the preferences. Alternatively, the user 70 can input a keyword into the keyword field 1610 to look for a specific item, such as “sandwich.” The DBMS 54 processes the inputted information and provides the alternate meal 1502 based on the keyword.

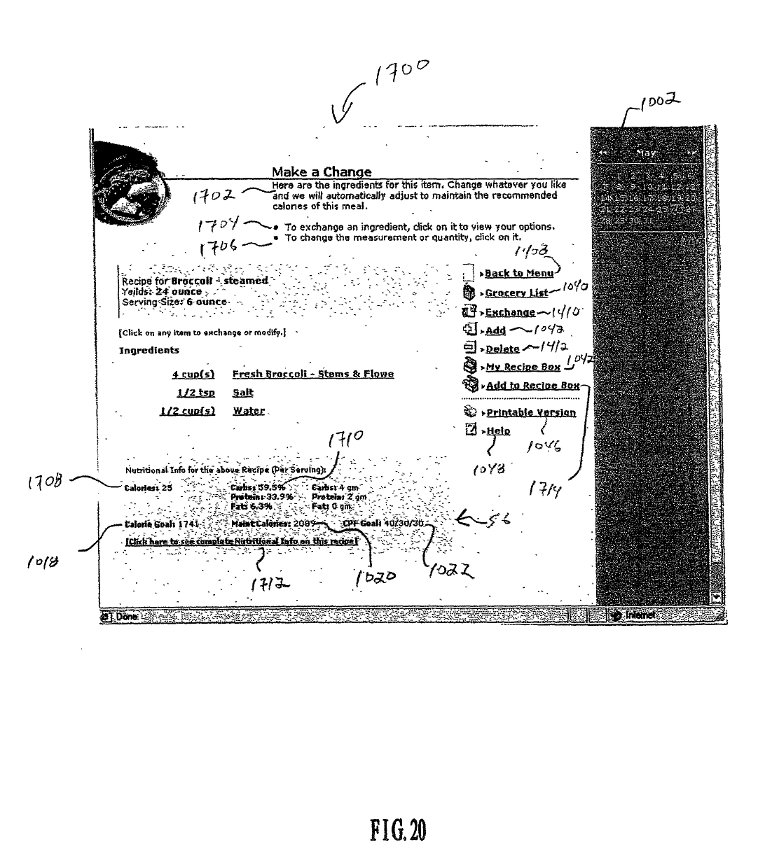

Referring back to FIG. 17, the user 70 may also modify the ingredients 1010 of a particular meal 1008 by clicking on the particular meal 1008 for which the user 70 desires to change ingredients 1010. The user 70 is then presented with the seventeenth screen 1700 that provides a list of the ingredients 1010 of the selected meal 1008 and gives the user 70 the option of modifying the ingredients 1010, as shown in FIG. 20.

By clicking on the appropriate hyperlinks shown in FIG. 20, the user 70 can modify the amounts and types of ingredients 1008 comprising the meal 1010. The user 70 can modify the measurement or quantity of an ingredient 1008 by clicking on it. The user 70 may also add ingredients 1008 to or remove ingredients 1008 from the recipe. In addition, the user 70 can exchange ingredients 1008 in the recipe by clicking on the ingredient 1008 to view the exchange options, and by clicking on link 1410 on screen 1700 that will take the user 70 to a screen that allows the user 70 to exchange the ingredient 1008.

The system 50, as described above, develops the meal plan 52 for a single user 70. Those skilled in the art will recognize that a comparable meal plan 52 for an additional person can be formed by doubling the meals 1008 and recipes 1104 generated by the system 50.

It is to be understood that changes could be made to the method described above without departing from the broad inventive concept thereof. It is understood, therefore, that this invention is not limited to the particular details covered in the method described above, but it is intended to cover modifications within the spirit and scope of the present invention as defined in the appended claims.

What is claimed is:

1. A multi-user meal planner comprising:
a relational database management system including:
nutritional information;
a user information database; and
an algorithm operationally connected to the nutritional information and the user information database;
wherein the algorithm processes the nutritional information and user information in the user information database and generates a modifiable meal plan.

2. The multi-user meal planner according to claim 1, wherein the database management system is accessed via a computer network.

3. The multi-user meal planner according to claim 1, wherein the database management system is adapted for use on one of a plurality of computer platforms.

4. The multi-user meal planner according to claim 3, wherein the one of the plurality of platforms comprises the Internet, a CDROM and a client/server LAN environment.

5. The multi-user meal planner according to claim 1, wherein the database management system processes the user information to generate a calorie goal for the user.

6. The multi-user meal planner according to claim 5, wherein the user information includes general demographic information and physical metric information.

7. The multi-user meal planner according to claim 1, wherein the database management system generates an individually customized meal plan by processing the user information, the user information comprising at least one of:
eating patterns;
metabolic responses to eating;
ethnic food preferences;
protein preferences; and
beverage preferences.

8. The multi-user meal planner according to claim 7, wherein the individually customized meal plan is modifiable through intervention by the user.

9. The multi-user meal planner according to claim 8, wherein the intervention comprises at least one of:
modification of amounts of ingredients in meal recipes;
modification of types of ingredients in meal recipes;
exchange of meal; and
modification of serving size.

10. The multi-user meal planner according to claim 7, wherein the individually customized meal plan is generated from recipes based on nutritional data of ingredients in the meal plan.

11. The multi-user meal planner according to claim 7, wherein the algorithm processes the preference information and selects a percentage of likelihood that particular ethnic foods, protein groups and beverages will be selected for the meal plan.

12. The multi-user meal planner according to claim 1, wherein the database management system processes the user information and generates a recommended ratio of carbohydrates, proteins and fats based on the user information.

13. The multi-user meal planner according to claim 12, wherein the database management system provides an indication of the meal falling more than a predetermined amount outside the recommended ratio.

14. The multi-user meal planner according to claim 1, wherein the user selects a preferred combination of meals and snacks, the combination comprising a daily eating pattern.

15. The multi-user meal planner according to claim 1, wherein the database management system generates an ingredient list for the user based on the meal plan.

16. The multi-user meal planner according to claim 1, wherein the database management system generates food preparation instructions.

17. The multi-user meal planner according to claim 16, wherein the food preparation instructions comprise specific cooking instructions.

18. A method of obtaining an individualized meal plan via a networked computer system comprising:
accessing the computer system;
inputting into the system at least one of:
personal information;
ethnic food preferences;
protein preferences;
carbohydrate, protein and fat preferences;
a desired number of meals per day;
a desired type of meals per day; and
beverage preferences; and
obtaining the meal plan based on at least one of the information and preferences inputted into the system.

19. The method according to claim 18, wherein obtaining the meal plan comprises obtaining the meal plan for specific calendar days.

20. The method according to claim 18, wherein obtaining the meal plan further comprises obtaining food preparation instructions.

21. The method according to claim 20, wherein obtaining food preparation instructions comprises obtaining specific cooking instructions.

22. The method according to claim 18, wherein obtaining the meal plan further comprises obtaining a list of ingredients.

23. The method according to claim 22, further comprising modifying the meal plan.

24. The method according to claim 23, wherein modifying the meal plan comprises exchanging a meal in the meal plan for an alternate meal.

25. The method according to claim 24, wherein exchanging the meal for the alternate meal comprises inputting an alternate ethnic food preference.

26. The method according to claim 24, wherein exchanging the meal for the alternate meal comprises inputting an alternate protein preference.

27. The method according to claim 23, wherein modifying the meal plan further comprises changing a serving size of a meal item.

28. The method according to claim 23, wherein modifying the meal plan further comprises altering the list of ingredients.

29. The method according to claim 18, further comprising, after obtaining the meal plan, modifying the meal plan.

30. The method according to claim 18, wherein obtaining the meal plan further comprises obtaining a nutritional analysis of the meal plan.

31. The method according to claim 30, wherein obtaining the nutritional analysis of the meal plan comprises obtaining a caloric value of the meal plan.

32. The method according to claim 31, further comprising modifying the meal plan, the caloric value of the meal plan being maintained.

33. The method according to claim 30, wherein obtaining the nutritional analysis of the meal plan further comprises obtaining a carbohydrate/protein/fat ratio for the meal plan.

34. A method of providing an individualized meal plan system comprising:
providing an input field in a relational database management system, the input field adapted to receive information inputted by a user;
transmitting the information to an algorithm in the database management system;
generating a meal plan based on the information; and
transmitting the meal plan to the user.

35. The method according to claim 34, wherein generating the meal plan comprises generating a modifiable meal plan.

36. The method according to claim 35, wherein generating the modifiable meal plan comprises allowing modification of individual ingredients.

37. The method according to claim 36, wherein allowing modification of the individual ingredients comprises allowing alteration of a list of ingredients.

38. The method according to claim 35, wherein generating the modifiable meal plan further comprises exchanging a meal in the meal plan for an alternate meal.

39. The method according to claim 35, wherein generating the modifiable meal plan further comprises allowing change of a serving size of a meal item.

40. The method according to claim 34, wherein generating the meal plan comprises providing a meal plan for specific calendar days.

41. The method according to claim 34, wherein generating the meal plan further comprises generating food preparation instructions.

42. The method according to claim 41, wherein generating food preparation instructions comprises generating specific cooking instructions.

43. The method according to claim 34, wherein generating the meal plan further comprises generating a list of ingredients.

44. The method according to claim 34, wherein generating the meal plan further comprises generating a nutritional analysis of the meals.

45. The method according to claim 44, wherein generating the nutritional analysis of the meals comprises generating a caloric value of the meals.

46. The method according to claim 45, wherein generating the caloric value of the meals comprises adjusting the meal plan to maintain the caloric value of the meal plan.

47. The method according to claim 44, wherein generating the nutritional analysis of the meals further comprises generating a carbohydrate/protein/fat ratio for the meals.

48. The method according to claim 34, wherein generating the meal plan further comprises generating a meal plan based on a user's inputted ethnic food preference.

49. The method according to claim 48, wherein generating the meal plan further comprises generating a modifiable meal plan.

50. The method according to claim 49, wherein generating the modifiable meal plan comprises exchanging a meal in the meal plan for an alternate meal.

51. The method according to claim 50, wherein exchanging the meal for the alternate meal comprises allowing the user to input an alternate ethnic food preference.

52. The method according to claim 34, wherein generating the meal plan further comprises generating a meal plan based on a user's inputted protein preference.

53. The method according to claim 52, wherein generating the meal plan further comprises generating a modifiable meal plan.

54. The method according to claim 53, wherein generating the modifiable meal plan comprises exchanging a meal in the meal plan for an alternate meal.

55. The method according to claim 54, wherein exchanging the meal for the alternate meal comprises allowing the user to input an alternate protein preference.
